(19) United States
(12) Patent Application Publication
(10) Pub. No.: US 2024/0127101 A1
(43) Pub. Date: Apr. 18, 2024

(54) OPTIMIZATION OF EXPECTATION VALUE CALCULATION WITH STATEVECTOR

(71) Applicant: International Business Machines Corporation, Armonk, NY (US)

(72) Inventors: Hiroshi Horii, Tokyo (JP); Ikko Hamamura, Tokyo (JP); Hitomi Chiba, Tokyo (JP)

(21) Appl. No.: 18/047,377

(22) Filed: Oct. 18, 2022

(51) Int. Cl. G06N 10/60

(52) U.S. Cl. CPC G06N 10/60

(57) ABSTRACT

Systems and techniques that facilitate expectation value calculation by grouping Pauli-strings are provided. In various embodiments, a system can comprise an expectation component that calculate expectation values of two Pauli-strings based on a first bit series of a first Pauli-string of the two Pauli-strings and a second bit series of a second Pauli-string of the two Pauli-strings, wherein bit series comprise a first value for a position of an x or y in a Pauli string and a second value for a position of a non-x or y in the Pauli-string.

### BACKGROUND

The subject disclosure relates to simulation of quantum circuits, and more specifically to the optimization of expectation value calculations with statevectors.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate optimization of expectation value calculation in quantum simulations.

According to an embodiment, a system can comprise a processor that executes computer executable components stored in memory. The computer executable components comprise an expectation component configured to calculate expectation values of two Pauli-strings based on a first bit series of a first Pauli-string of the two Pauli-strings and a second bit series of a second Pauli-string of the two Pauli-strings, wherein bit series comprise a first value for a position of an X or Y in a Pauli string and a second value for a position of a non-X or Y in the Pauli string.

In some embodiments, the computer executable components can further comprise a comparison component configured to determine that the first bit series and the second bit series are the same.

According to another embodiment, a computer-implemented method can comprise calculating, by a system operatively coupled to a processor, expectation values of two Pauli-strings based on a first bit series of a first Pauli-string of the two Pauli-strings and a second bit series of a second Pauli-string of the two Pauli-strings, wherein bit series comprise a first value for a position of an X or Y character in a Pauli string and a second value for a position of a non-X or Y character in the Pauli string.

In some embodiments, the above computer-implemented method can further comprise, determining, by the system, that the first bit series and the second bit series are the same.

According to another embodiment, a computer program product comprising a computer readable storage medium having program instructions embodied therewith, the program instructions executable by a processor to cause the processor to calculate, by the processor, expectation values of two Pauli-strings based on a first bit series of a first Pauli-string of the two Pauli-strings and a second bit series of a second Pauli-string of the two Pauli-strings, wherein bit series comprise a first value for a position of an X or Y in a Pauli string and a second value for a position of a non-X or Y in the Pauli string.

In some embodiments, the program instructions are further executable by the processor to cause the processor to determine that that that the first bit series and the second bit series are the same.

### DESCRIPTION OF THE DRAWINGS

FIG. 1 illustrates block diagram of an example, non-limiting system that can facilitate optimization of expectation value calculation in quantum simulations in accordance with one or more embodiments described herein.

FIG. 2 illustrates a flow diagram of an example, non-limiting computer implemented method for determining an expectation value of a single Pauli-string in accordance with one or more embodiments described herein.

FIGS. 3A and 3B illustrate a flow diagram of an example, non-limiting computer implemented method for determining expectation values of two Pauli-strings in accordance with one or more embodiments described herein.

FIG. 4 illustrates examples of pairwise probability amplitudes of two Pauli-strings, in accordance with one or more embodiments described herein.

FIG. 5 illustrates examples of pairwise probability amplitudes of two Pauli-strings, in accordance with one or more embodiments described herein.

FIG. 6 illustrates examples of pairwise probability amplitudes of two Pauli-strings, in accordance with one or more embodiments described herein.

FIG. 7 illustrates a flow diagram of an example, non-limiting computer-implemented method that can facilitate optimization of expectation value calculation in accordance with one or more embodiments described herein.

FIG. 8 illustrates a flow diagram of an example, non-limiting computer-implemented method that can facilitate optimization of expectation value calculation in accordance with one or more embodiments described herein.

FIG. 9 illustrates an example code block that can facilitate one or more operations described herein.

FIG. 10 illustrates a graph showing simulation time of expectations values in accordance with one or more embodiments described herein.

FIG. 11 illustrates an example, non-limiting environment for the execution of at least some of the computer code in accordance with one or more embodiments described herein.

FIG. 12 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

Quantum computing is generally the use of quantum-mechanical phenomena to perform computing and information processing functions. Quantum computing can be viewed in contrast to classical computing, which generally operates on binary values with transistors. That is, while classical computers can operate on bit values that are either 0 or 1, quantum computers operate on quantum bits (qubits) that comprise superpositions of both 0 and 1. Quantum computing has the potential to solve problems that, due to computational complexity, cannot be solved or can only be solved slowly on a classical computer.

However, due to the cost and complexity of quantum computing systems, classical computing systems are often utilized to perform simulations of quantum systems. As quantum computing systems have greater computational complexity than classical computing systems, quantum simulations are often slow and limited by memory load operations and memory capacity.

For example, in various simulation architectures, a n-bit Pauli-string is used to represent an n-qubit Pauli. In order to calculate expectation values, such as those utilized in Variational Quantum Eigensolvers, probability amplitudes of thousands of Pauli-strings are loaded thousands of times, leading to large memory requirements and a large number of memory operations, leading to limitations on the size of quantum systems that can be simulated and the speed at which quantum systems can be simulated. For example, in order to calculate an expectation value of a single Pauli-string, the gates represented in the Pauli-string are applied to a first statevector to generate a second statevector. As part of this process, probability amplitudes are loaded from the statevector. Accordingly, in existing simulation methods, the same statevectors are loaded multiple times for similar Pauli-stings, resulting in a large number of memory operations. In order to decrease load times, pairwise probability amplitudes can be identified using an xy mask of a single Pauli string to enable the load of multiple probability amplitudes without an update of a statevector. However, this still leads to multiple re-loads of the statevector as multiple Pauli-strings can require the loading of the same statevector. Accordingly, this disclosure provides for systems, computer-implemented methods and computer-program products that can reduce memory load operations of quantum simulations by grouping similar Pauli-strings together and loading a statevector a single time for multiple Pauli-strings.

In an embodiment, bit series or bit masks for Pauli-strings can be calculated, wherein certain characters of the Pauli-stings are replaced with a 1 bit and other characters of the Pauli-string are replaced with a 0 bit. For example, given a Pauli string XZZY, an xy mask can be generated wherein X and Y characters are replaced with a 1 bit and other characters are replaced with a 0. Accordingly, the xy mask of XZZY is 1001. It should be appreciated that other Pauli-strings, such as XIZY, share the xy mask of 1001. As described in greater detail below, Pauli-strings XZZY and XIZY can then be grouped together to load probability amplitudes of both with a single load of a statevector. For example, as pairwise probability amplitudes are determined based on xy masks, two Pauli stings with the same xy mask with share all pairwise probability amplitudes and thus can be grouped together to enable the determination of pairwise probability amplitudes once as opposed to twice.

In another embodiment, Pauli-stings can be grouped together based on a shared position of ‘X’ or ‘Y’. For example, given the Pauli-strings XZZY and IZZY, the respective xy masks are 1001 and 0001. As shown, the respective xy masks share a 1 bit in the fourth position. As described in greater detail below, Pauli-strings XZZY and IZZY can be grouped together to load probability amplitudes of both with a single load of a statevector. For example, as pairwise probability amplitudes are calculated based on xy masks, two xy masks with a shared bit position of 1, will share some pairwise probability amplitudes enabling determination of the shared probability amplitudes once as opposed to multiple times.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

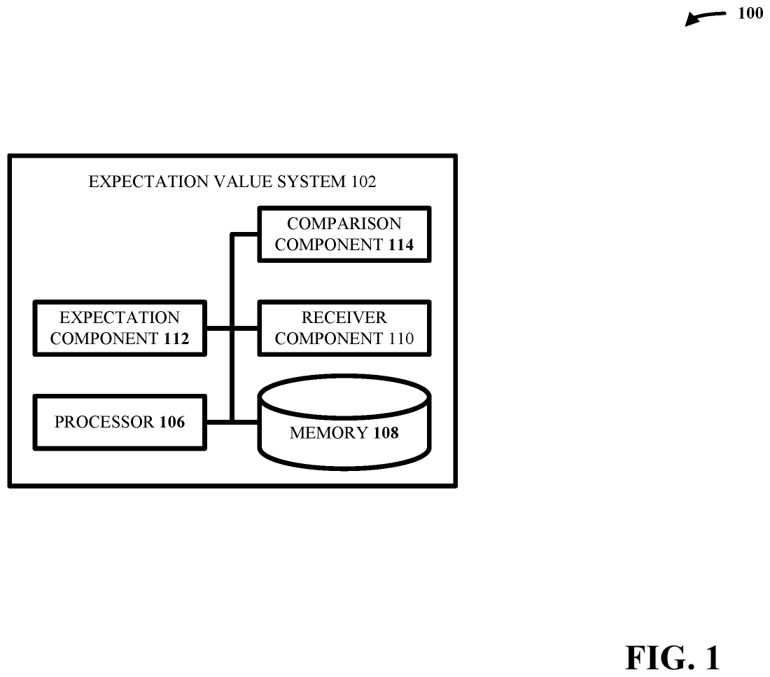

FIG. 1 illustrates block diagram of an example, non-limiting system 100 that can facilitate optimization of expectation value calculation in quantum simulations. Repetitive description of like elements employed in other embodiments described herein is omitted for sake of brevity. Aspects of systems (e.g., system 100 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 100 can comprise comparison component 114, expectation component 112, receive component 110, processor 106 and memory 108.

In various embodiments, expectation value system 102 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the expectation value system 102 (e.g., receiver component 110, expectation component 112 and/or comparison component 114) to perform one or more acts. In various embodiments, the memory 108 can store computer-executable components (e.g., receiver component 110, expectation component 112 and/or comparison component 114), the processor 106 can execute the computer-executable components.

In one or more embodiments, receiver component 110 can receive a set of Pauli-strings for an expectation value simulation. For example, receiver component 110 can receive a set of Pauli-strings for use in a variational quantum eigensolver (VQE) simulation. Receiver component 110 can generate bit series for the Pauli strings. For example, receive component 110 can generate a bit series (e.g., xy mask) for a Pauli-string by replacing X or Y characters in the Pauli-string with a first bit value and non X or Y characters with a second bit value. In an embodiment, the first bit value can comprise a 1 bit and the second bit value can comprise a 0 bit. Given the Pauli-string ZYXI, receiver component 110 can generate the bit string, or xy mask, 0110.

In one or more embodiment, comparison component 114 can select two or more Pauli-strings from the set of Pauli-strings and compare the bit series of the selected Pauli-strings. For example, comparison component 114 can select a first Pauli-string and a second Pauli-string. Comparison component 114 can determine if a first bit series (e.g., xy mask) of the first Pauli-string is the same as a second bit series (e.g., xy mask) of the second Pauli-string. If the first bit series and the second bit series are identical, then the first Pauli-string and the second Pauli-string can be grouped together. In a further embodiment, comparison component 114 can determine if a position of the first bit value is the same in the first bit series and the second bit series. For example, given first bit series 100 and second bit series 101, comparison component 114 can determine that first bit series 100 and second bit series 101 share a value of 1 in the first position. Accordingly, comparison component 114 can group the first Pauli-string and the second Pauli-string. It should be appreciated that while examples herein are described in relation to two Pauli-strings, any number of Pauli-strings can be compared and grouped together.

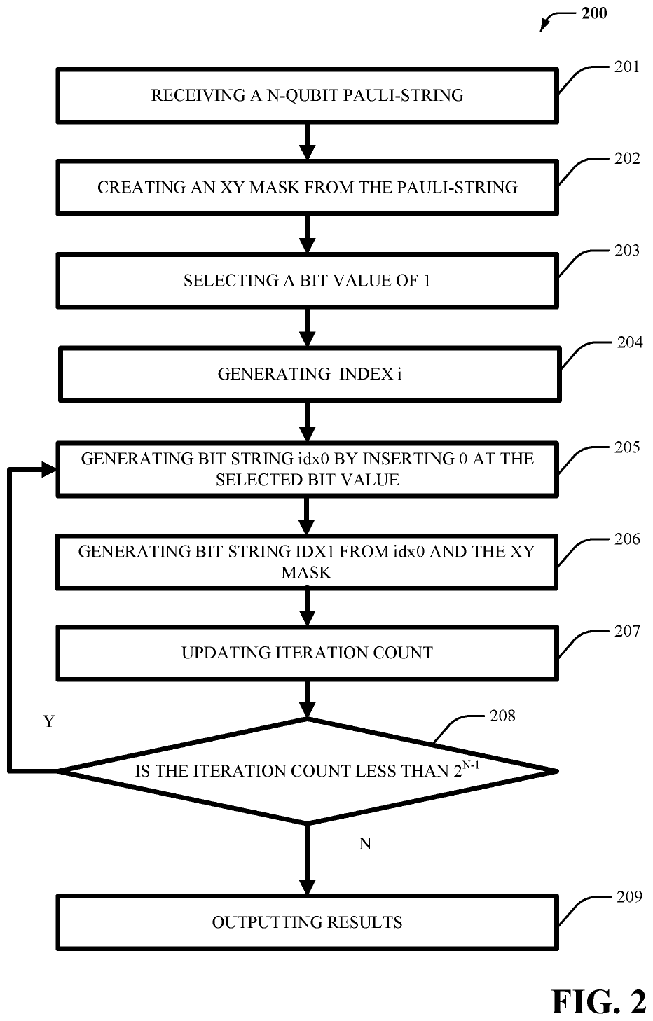

Turning to FIG. 2, an example computer implemented method 200 for determining an expectation value of a single Pauli-string is illustrated. Repetitive description of like elements and/or processes employed in respective embodiments is omitted for sake of brevity.

At 201, computer-implemented method 200 can comprise receiving, by a system (e.g., expectation value system 102 and/or receiver component 110) operatively coupled to a processor (e.g., processor 106), an n-qubit Pauli-string, wherein n is the number of qubits.

At 202, computer-implemented method 200 can comprise creating, by the system (e.g., expectation value system 102 and/or receiver component 110), an xy mask from the Pauli string by replacing x or y characters with 1 bits and other characters with 0 bits. For example, given the Pauli-string ZXI, the xy mask generated is 010.

At 203, computer-implemented method 200 can comprise selecting, by the system (e.g., expectation value system 102 and/or expectation component 112), a bit value of 1. For example, given the xy mask 010, the second bit is selected.

At 204, computer-implemented method 200 can comprise generating, by the system (e.g., expectation value system 102 and/or receiver component 110), an index comprising 2^{N-1} elements. For example, the index can comprise all n-bit strings, wherein the selected bit from step 103 is left blank. Accordingly, the index of xy mask 010 comprises the values of 0_0, 1_0, 0_1 and 1_1.

At 205, computer-implemented method 200 can comprise generating, by the system (e.g., expectation value system 102 and/or receiver component 110), a first bit string by inserting a 0 at the bit selected at step 203 into the current index item. For example, on a first loop iteration, the index value of 0_0 is selected and a bit string of 000 is generated.

At 206, computer-implemented method 200 can comprise generating, by the system (e.g., expectation value system 102 and/or receiver component 110), a second bit string by performing an exclusive or (XOR) operation on the first bit string and the xy mask. XOR operations compare two bits and return a 0 if the two bits are the same and a 1 if the two bits are different. Accordingly, given the first bit string of 000 and the xy mask of 010, the second bit string is 010, wherein the first bit string and the second bit string are pairwise probability amplitudes that can be loaded from a single load of a statevector.

At 207, computer-implemented method 200 can comprise, updating, by the system (e.g., expectation value system 102 and/or expectation component 112), an iteration count for example, the iteration count can be increased by 1.

At 208, computer-implemented method 200 can comprise determining, by the system (e.g., expectation value system 102 and/or expectation component 112), if the iteration count is less than 2^{N-1} (e.g., the number of elements in the index). For example, if the iteration count is less that the number of elements, then method 200 can return to step 205 and generate the next pair of probability amplitudes using the updated iteration count to select the next index value. If the iteration count is equal to the number of elements in the index, then the selected pairs of probability amplitudes can be output.

Returning to FIG. 1, expectation component 112 can calculate expectation values of two Pauli-strings based on a first bit series of a first Pauli-string of the two Pauli-strings and a second bit series of a second Pauli-string of the two Pauli-strings. In an embodiment, expectation component 112 can load probability amplitudes of an index value and an exclusive or result of the index value and the first bit series. For example, expectation component 112 can receive groups of Pauli-strings from comparison component 114. Expectation values are calculated using pairwise probability amplitudes from statevectors that are multiplied by a phase value. As the pairs of probability amplitudes are determined using the bit series or xy mask of a Pauli-string, if two Pauli-strings have identical xy masks, then all the pairs of expectation values for the two Pauli-strings will be the same. Accordingly, the probability amplitudes for both the first Pauli-string and the second Pauli-string can be loaded simultaneously to decrease the number of memory operations. For example, given two Pauli-strings with the same xy mask or bit series, expectation component 112 can calculate two phases from Y positions of the two Pauli-strings. Expectation component 112 can determine pairs of probability amplitudes using the computer implemented method desired in FIG. 2. For each probability amplitude, expectation component 112 can multiply the amplitude by a phase to calculate an expectation value.

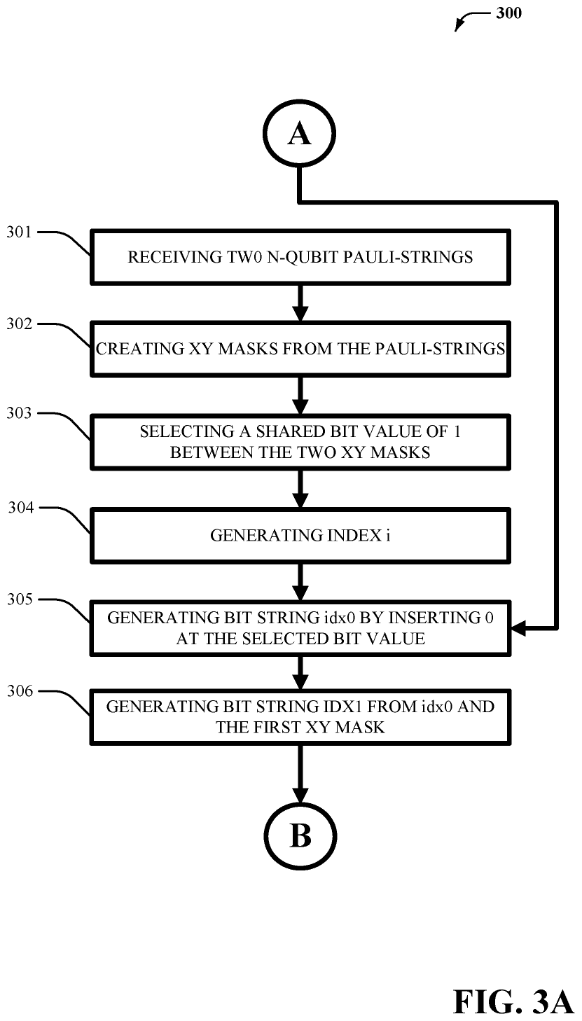

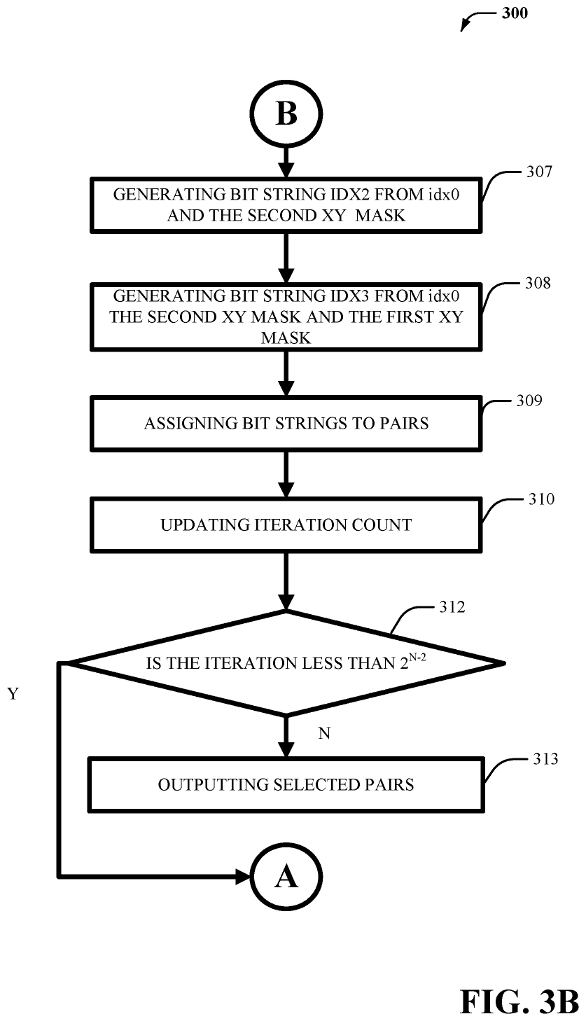

In a further embodiment, expectation component 112 can receive pairs or groups of Pauli-strings, wherein the bit series or xy masks of the Pauli strings share a position of a first value. For example, the first bit series (e.g., xy mask) of a first Pauli-string and the second bit string of a second Pauli-string (e.g., xy mask) can share a position of a bit value of 1. Expectation component 112 can then load probability amplitudes of an index value, an exclusive or result of the index value and the first bit series, a second exclusive or result of the index value and the second bit series, and a third exclusive or result of the index value, the second bit series and the first bit series, as more fully described in FIGS. 3A and 3B.

Turning to FIGS. 3A and 3B, an example computer implemented method 300 for determining an expectation value of a two Pauli-strings that share a position of x or y is illustrated. Repetitive description of like elements and/or processes employed in respective embodiments is omitted for sake of brevity.

At 301, computer-implemented method 300 can comprise receiving, by a system (e.g., expectation value system 102 and/or receiver component 110) operatively coupled to a processor (e.g., processor 106), an n-qubit Pauli-string, wherein n is the number of qubits.

At 302, computer-implemented method 300 can comprise generating, by the system (e.g., expectation value system 102 and/or receiver component 110), an xy mask from the Pauli string by replacing x or y characters with 1 bits and other characters with 0 bits. For example, given a first Pauli-string ZXI, the first xy mask generated is 010 and given a second Pauli-string YXZ, the second xy mask generated is 110.

At 303, computer-implemented method 300 can comprise, selecting, by the system (e.g., expectation value system 102 and/or comparison component 114), a position for which the first bit series and the second bit series share a value of 1. For example, given the bit series 010 and 110 the second bit is selected.

At 304, computer-implemented method 300 can comprise generating, by the system (e.g., expectation value system 102 and/or expectation component 112), an index comprising 2′ 1 elements from the first bit series. For example, the index can comprise all n-bit strings, wherein the bit selected at step 303 is left blank. Accordingly, the index of xy mask 010 comprises the values of 0_0, 1_0, 0_1 and 1_1.

At 305, computer-implemented method 300 can comprise generating, by the system (e.g., expectation value system 102 and/or expectation component 112), a first bit string by inserting a 0 at the bit selected at step 303 into the current index item. For example, on a first loop iteration, the first index value of 0_0 is selected and a bit string of 000 is generated.

At 306, computer-implemented method 300 can comprise generating, by the system (e.g., expectation value system 102 and/or expectation component 112), a second bit string by performing an exclusive or (XOR) operation on the first bit string and the first xy mask. XOR operations compare two bits and return a 0 if the two bits are the same and a 1 if the two bits are different. Accordingly, given the first bit string of 000 and the first xy mask of 010, the second bit string is 010.

At 307, computer-implemented method 300 can comprise generating, by the system (e.g., expectation value system 102 and/or expectation component 112), a third bit string by performing an exclusive or (XOR) operation on the first bit string and the second xy mask. Accordingly, given the first bit string 000 and the second xy mask of 110, the third bit string is 001.

At 308, computer-implemented method 300 can comprise generating, by the system (e.g., expectation value system 102 and/or expectation component 112), a fourth bit string by performing an XOR operation on the first bit string, the second xy mask, and the first xy mask. For example, given the first bit string 000, the second xy mask 110 and the first xy mask 010, the fourth bit string is 011.

At 309, computer-implemented method 300 can comprise assigning, by the system (e.g., expectation value system 102 and/or expectation component 112), the bit strings to pairs. For example, the first bit string and the second bit string can be grouped as a first set of pairwise probability amplitudes for the first Pauli-string and the third bit string and the fourth bit string can be grouped as a second set of pairwise probability amplitudes for the first Pauli-string. The first bit string and the third bit string can be grouped as a first set of pairwise probability amplitudes for the second Pauli-string and the second bit string and the third bit string can be grouped as a second set of pairwise probability amplitudes for the second Pauli-string.

At 310, computer-implemented method 300 can comprise, updating, by the system (e.g., expectation value system 102 and/or expectation component 112), an iteration count for example, the iteration count can be increased by 1.

At 312, computer-implemented method 300 comprise determining, by the system, (e.g., expectation value system 102 and/or expectation component 112), if the iteration count is less than 2′. For example, if the iteration count is less than 2′, then method 300 can return to step 305 and generate the next four pairs of probability amplitudes by generating a new first bit string using the current iteration count to select a value from the index. If the iteration count is equal to 2′, then the pairs of probability amplitudes can be output.

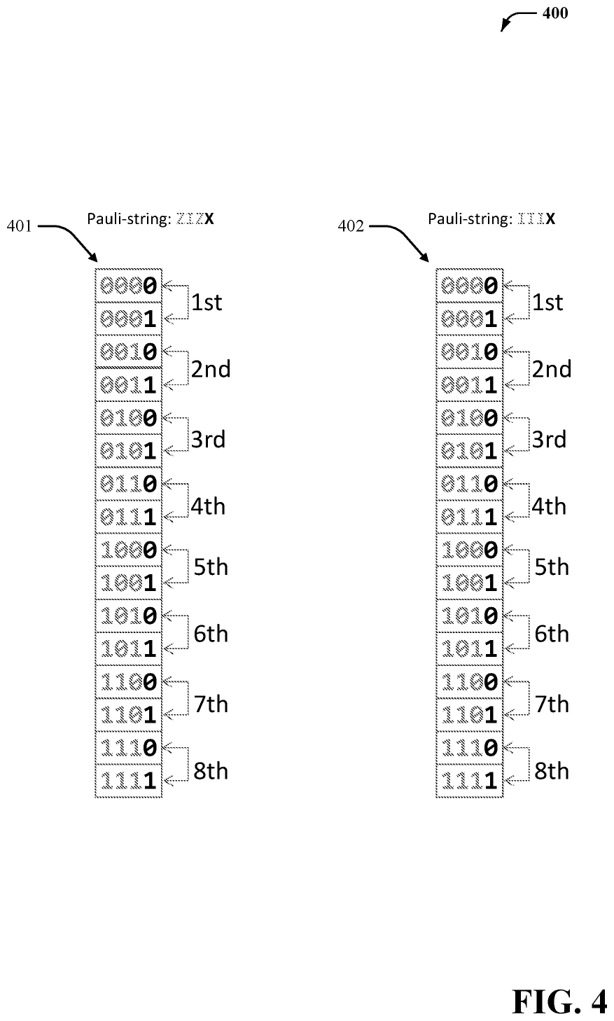

FIG. 4 illustrates examples of pairwise probability amplitudes of two Pauli-strings, in accordance with one or more embodiments described herein.

Column 401 illustrates eight pairs of probability amplitudes of the Pauli string ZIZX with the corresponding xy mask of 0001. Column 402 illustrates eight pairs of probability amplitudes of the Pauli-string IIIX with the corresponding xy mask of 0001. Without grouping, loading of probability amplitudes of Pauli-string ZIZX and Pauli-string IIIX would call for sixteen iterations, eight each, resulting in long processing times and a high amount of memory usage and storage operations.

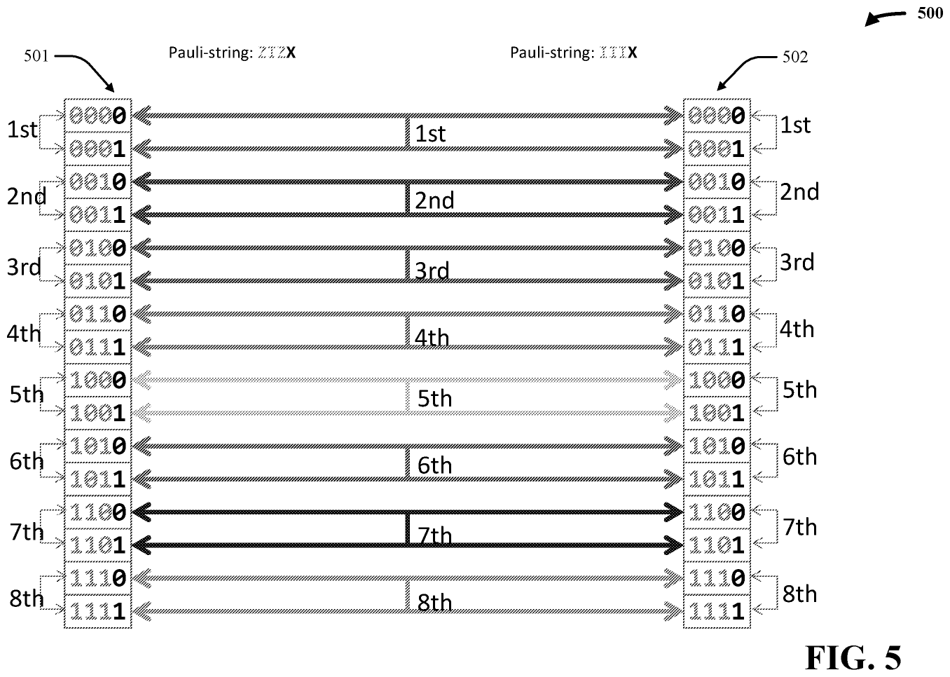

FIG. 5 illustrates examples of pairwise probability amplitudes of two Pauli-strings, in accordance with one or more embodiments described herein.

Column 501 illustrates eight pairs of probability amplitudes of the Pauli-string ZIZX with the corresponding xy mask of 0001. Column 502 illustrates eight pairs of probability amplitudes of the Pauli-string IIIX with the corresponding xy mask of 0001. As shown, ZIZX and IIIX share all the same pairwise probability amplitudes, due to having the same xy mask. Accordingly, the two Pauli-strings can be grouped together as described and the probability amplitudes can be loaded simultaneously, resulting in eight iterations of loading probability amplitude pairs as opposed to the sixteen iterations otherwise called for.

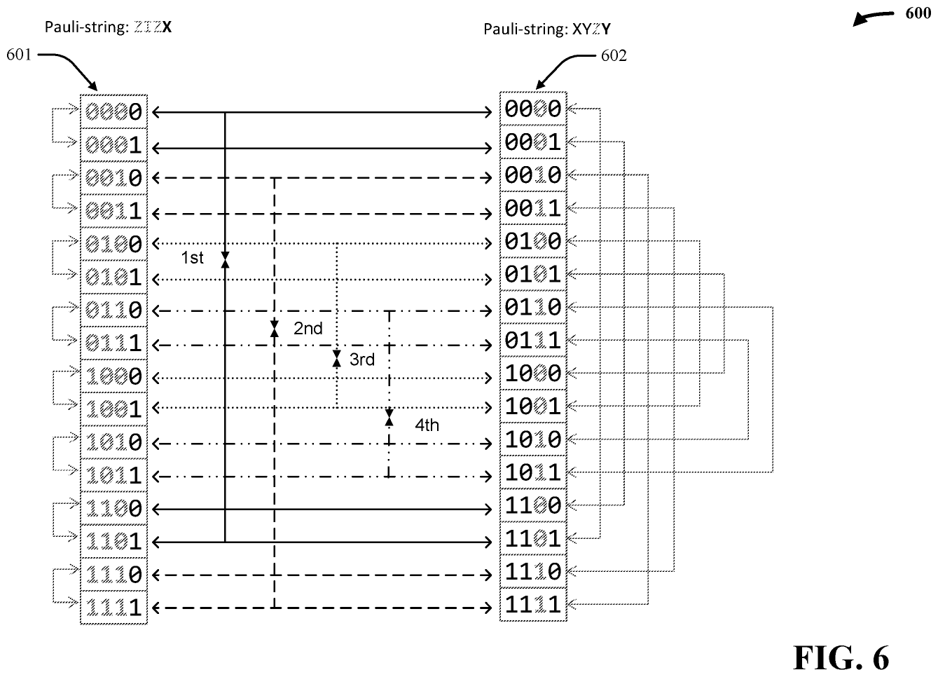

FIG. 6 illustrates examples of pairwise probability amplitudes of two Pauli-strings, in accordance with one or more embodiments described herein.

Column 601 illustrates eight pairs of probability amplitudes of the Pauli-string ZIZX with the corresponding xy mask of 0001. Column 602 illustrates eight pairs of probability amplitudes of the Pauli-string XYZY with the corresponding xy mask of 1101. As shown, the xy masks of ZIZX and XYZY share a position of the bit value of 1 at the fourth position. Accordingly, pairwise probability amplitudes can be selected for both ZIZX and XYZY together using the computer-implemented method described in detail in FIGS. 3A and 3B. As shown, a first iteration of method 300 can produce a first set of probability amplitudes for ZIZX of 0000 and 0001 and a second set of probability amplitudes for ZIZX of 1100 and 1101, a first set of probability amplitudes for XYZY of 0000 and 1101, and a second set of probability amplitudes for XYZY of 0001 and 1100. Accordingly, it should be appreciated that method 300 enables loading of eight pairs of probability amplitudes for two Pauli-strings in four iterations, as opposed to sixteen iterations, eight each, when loading probability amplitudes for the two Pauli-strings separately.

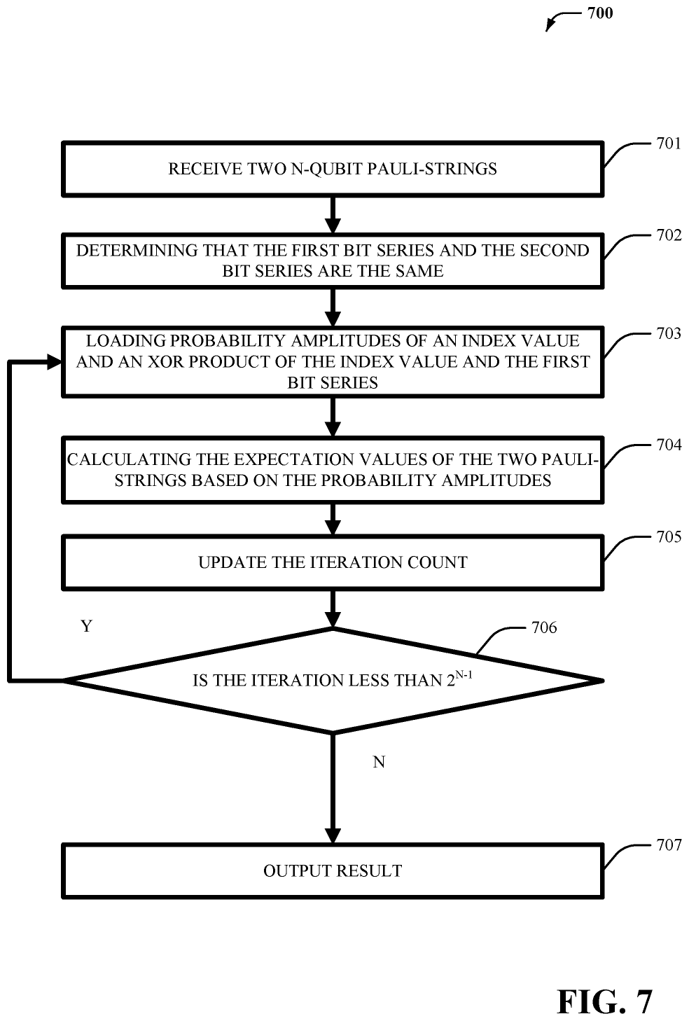

FIG. 7 illustrates a flow diagram of an example, non-limiting computer-implemented method 700 that can facilitate optimization of expectation value calculation in accordance with one or more embodiments described herein. Repetitive description of like elements and/or processes employed in respective embodiments is omitted for sake of brevity.

At 701, computer-implemented method 700 can comprise receiving, by a system (e.g., expectation value system 102 and/or receiver component 110) operatively coupled to a processor (e.g., processor 106), two n-qubit Pauli-strings. In an embodiment, receiver component 110 can receive a first Pauli-string and a second Pauli-string and generate a first bit series for the first Pauli-string and a second bit series for the second Pauli-string, wherein bit series comprise a first value for a position of an X or Y character in a Pauli string and a second value for a position of a non-X or Y character in the Pauli string. For example, xy masks for the Pauli-strings can be generated by replacing X or Y characters with a bit value of 1 and non-X or Y characters with a bit value of 0.

At 702, computer-implemented 700 can comprise determining, by the system (e.g., expectation value system 102 and/or comparison component 114) that the first bit series and the second bit series are the same. For example, comparison component 114 can compare the bit values of the first bit series and the second bit series to determine if the bit series are identical.

At 703, computer-implemented method 700 can comprise loading, by the system (e.g., expectation value system 102 and/or expectation component 112), probability amplitudes of an index value and an XOR result of the index value and the first bit series. For example, the index value can be generated using an index and an iteration count as described in greater detail in reference to FIGS. 1 and 2.

At 704, computer-implemented method 700 can comprise calculating, by the system, expectation values of the two Pauli-strings based on the probability amplitudes loaded at step 703.

At 705, computer-implemented method 700 can comprise updating, by the system (e.g., expectation value system 102 and/or expectation component 112), the iteration count. For example, the iteration count can be increased to reflect which iteration was completed at step 704.

At 706, computer-implemented method 700 can comprise, determining, by the system (e.g., expectation value system 102 and/or expectation component 112), if the iteration is less than or equal to 2^{N-1}, wherein n is the number of qubits in the Pauli-strings. If the iteration count is less that 2^{N-1}, computer-implemented method 700 can iterate back to step 703 and load the next iteration of probability amplitudes utilizing the updated iteration count. Otherwise, computer-implemented method 700 can proceed to step 707 and output the results of the expectation value calculation.

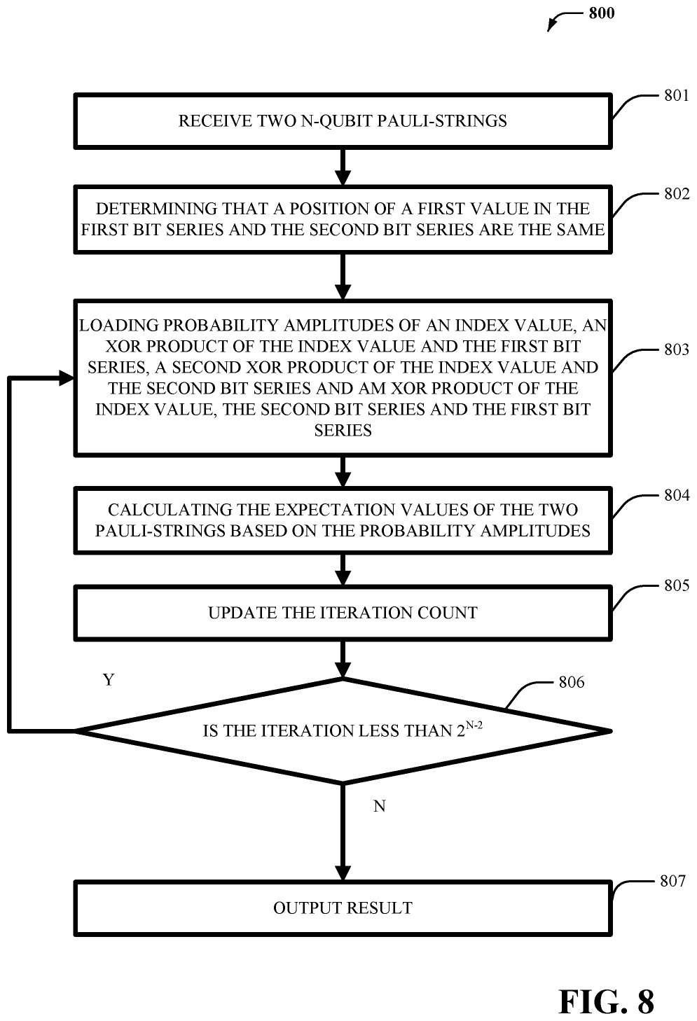

FIG. 8 illustrates a flow diagram of an example, non-limiting computer-implemented method 800 that can facilitate optimization of expectation value calculation in accordance with one or more embodiments described herein. Repetitive description of like elements and/or processes employed in respective embodiments is omitted for sake of brevity.

At 801, computer-implemented method 800 can comprise receiving, by a system (e.g., expectation value system 102 and/or receiver component 110) operatively coupled to a processor (e.g., processor 106), two n-qubit Pauli-strings. In an embodiment, receiver component 110 can receive a first Pauli-string and a second Pauli-string and generate a first bit series for the first Pauli-string and a second bit series for the second Pauli-string, wherein bit series comprise a first value for a position of an X or Y character in a Pauli string and a second value for a position of a non-X or Y character in the Pauli string. For example, xy masks for the Pauli-strings can be generated by replacing X or Y characters with a bit value of 1 and non-X or Y characters with a bit value of 0.

At 802, computer-implemented 800 can comprise determining, by the system (e.g., expectation value system 102 and/or comparison component 114) that a position of a first value in the first bit series and the second bit series are the same. For example, comparison component 114 can compare the bit values of the first bit series and the second bit series to determine that the first bit series and the second bit share position of a bit value of 1.

At 803, computer-implemented method 800 can comprise loading, by the system (e.g., expectation value system 102 and/or expectation component 112), probability amplitudes of an index value, an XOR result of the index value and the first bit series, as second XOR result of the index value and the second bit series and a third XOR result of the index value, the second bit series and the first bit series. For example, the index value can be generated using an index and an iteration count as described in greater detail in reference to FIGS. 1 and 3.

At 804, computer-implemented method 800 can comprise calculating, by the system, expectation values of the two Pauli-strings based on the probability amplitudes loaded at step 703.

At 805, computer-implemented method 800 can comprise updating, by the system (e.g., expectation value system 102 and/or expectation component 112), the iteration count. For example, the iteration count can be increased to reflect which iteration was completed at step 804.

At 806, computer-implemented method 800 can comprise, determining, by the system (e.g., expectation value system 102 and/or expectation component 112), if the iteration is less than or equal to 2^{N-2}, wherein n is the number of qubits in the Pauli-strings. If the iteration count is less that 2^{N-2}, computer-implemented method 800 can iterate back to step 803 and load the next iteration of probability amplitudes utilizing the updated iteration count. Otherwise, computer-implemented method 800 can proceed to step 807 and output the results of the expectation value calculation.

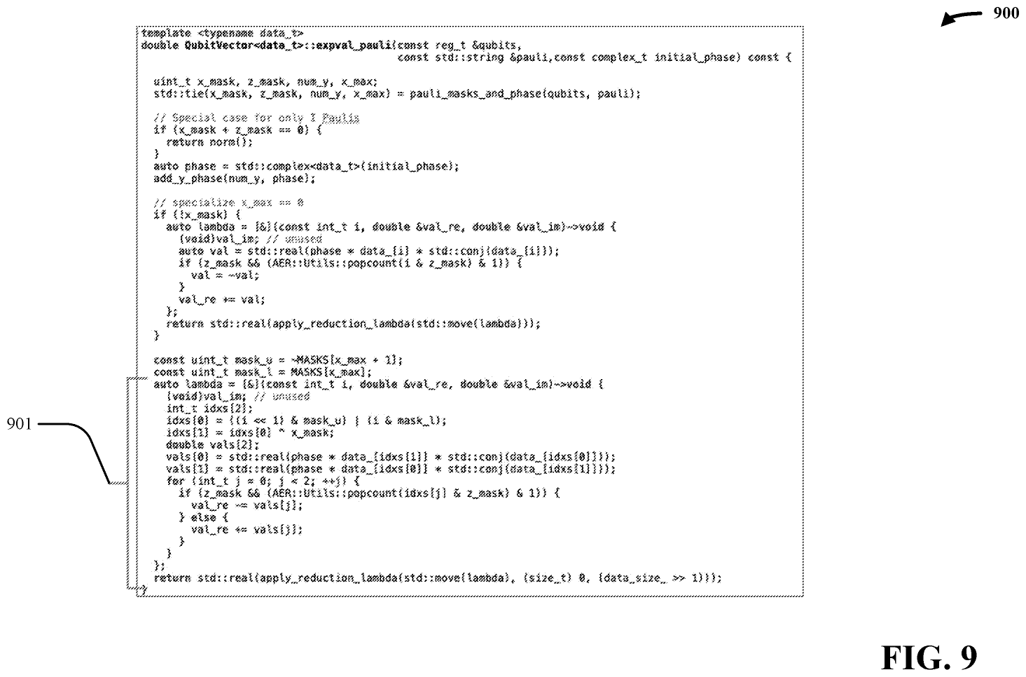

FIG. 9 illustrates an example code block 900 that can facilitate one or more operations described herein. Repetitive description of like elements and/or processes employed in respective embodiments is omitted for sake of brevity. As shown, code section 901 of code block 900 can facilitate performance of computer-implemented method 200, as described in reference to FIG. 2, in the Qiskit simulation architecture.

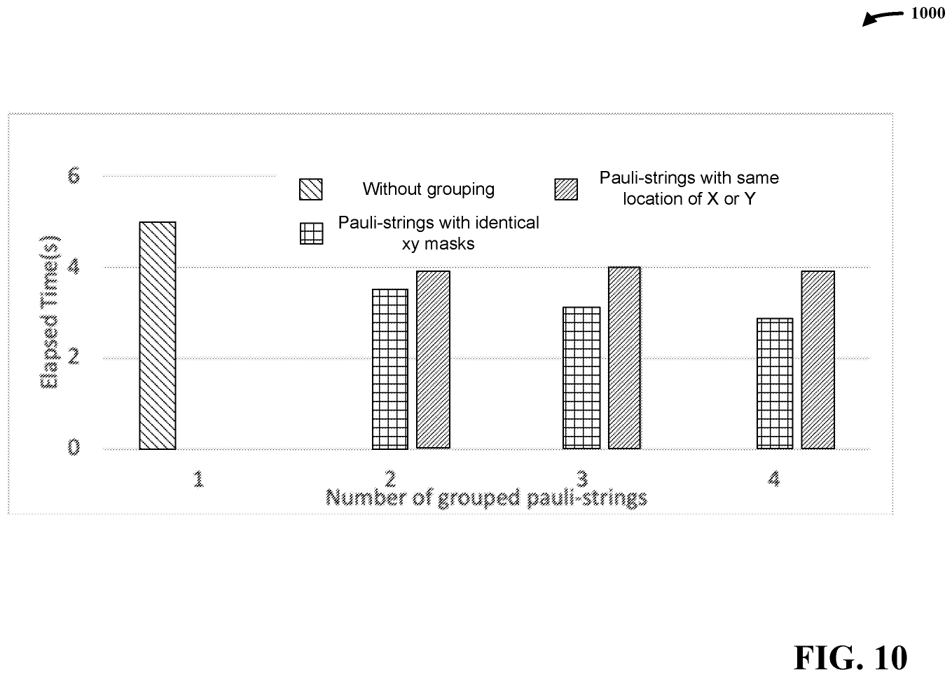

FIG. 10 illustrates a graph 1000 showing simulation time of expectations values in accordance with one or more embodiments described herein. Repetitive description of like elements and/or processes employed in respective embodiments is omitted for sake of brevity.

Y-axis of graph 1000 represents simulation time of an expectation value of a one thousand Pauli-string circuit with 20 qubits.

X-axis of graph 1000 represents the number of Pauli-strings grouped together. As shown, both grouping Pauli-strings with identical xy masks and based on a shared position of 1 in the respective xy masks offer decreases in simulation time when compared to not grouping Pauli-strings.

Expectation value system 102 can provide technological improvements to systems, devices, components, operational steps, and/or processing steps associated with performing quantum simulations. For example, expectation value system 102 can group multiple Pauli-strings together for evaluation, enabling greater number of Pauli-strings and more complex quantum circuits to be simulated using conventional computer hardware.

Expectation value system 102 can provide technical improvements to a processing unit associated with expectation value system 102. For example, by grouping Pauli-strings together, pairs of probability amplitudes for multiple Pauli-strings can be loaded during the same iterations, decreasing the overall number of iterations used to load pairs of probability amplitudes, thereby reducing the workload of a processing unit (e.g., processor 106) that is employed to execute the routines (e.g., instructions and/or processing threads) involved in simulating quantum circuits. In this example, by reducing the workload of such a processing unit (e.g., processor 106), expectation value system 102 can thereby facilitate improved performance, improved efficiency, and/or reduced computational cost associated with such a processing unit.

Expectation value system 102 can provide technical improvements to a memory unit associated with expectation value system 102. For example, by grouping Pauli-strings together, pairs of probability amplitudes for multiple Pauli-strings can be loaded during the same iterations, decreasing the overall number of load operations used to load statevectors, thereby reducing the workload of a memory unit (e.g., memory 108) that is employed to store data and instructions employed to execute the routines involved in simulating quantum circuits. In this example, by reducing the workload of such a memory unit (e.g., memory 108), expectation value system 102 can thereby facilitate improved performance, improved efficiency, and/or reduced computational cost associated with such a memory unit.

A practical application of expectation value system 102 is that it allows for a quantum simulation that can be performed in a reduced amount of time, using a reduced amount of computing resources, and/or allow for simulation of more complex quantum circuits.

Expectation value system 102 can employ hardware and/or software to solve problems that are highly technical in nature, that are not abstract and that cannot be performed as a series of mental acts by a human. In some embodiments, one or more of the processed described herein can be performed by one or more specialized computers (e.g., a specialized processing unit, a specialized classical computer, a specialized quantum computer, and/or another type of specialized computer) to execute defined tasks related to the various technologies identified above. Resource scheduling system 201 and/or components thereof, can be employed to solve new problems that arise through advancements in technologies mentioned above, employment of quantum computing systems, cloud computing systems, computer architecture, and/or another technology.

It is to be appreciated that expectation value system 102 can utilize various combinations of electrical components, mechanical components, and circuitry that cannot be replicated in the mind of a human or performed by a human as the various operations that can be executed by expectation value system 102 and/or components thereof as described herein are operations that are greater than the capability of a human mind. For instance, the amount of data processed, the speed of processing such data, or the types of data processed by expectation value system 102 over a certain period of time can be greater, faster, or different than the amount, speed, or data type that can be processed by a human mind over the same period of time. According to several embodiments, expectation value system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that expectation value system 102 can include information that is impossible to obtain manually by an entity, such as a human user. For example, the type, amount, and/or variety of information included in expectation value system 102 can be more complex than information obtained manually by an entity, such as a human user.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as expectation value code block 1150. In addition to block 1150, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1150, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

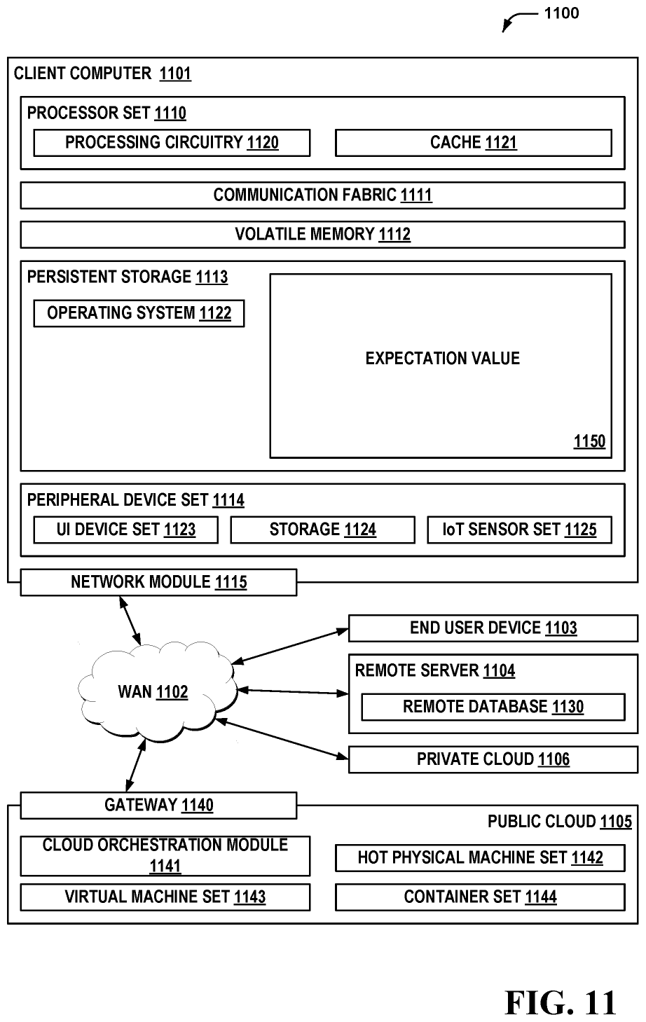

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1150 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1150 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

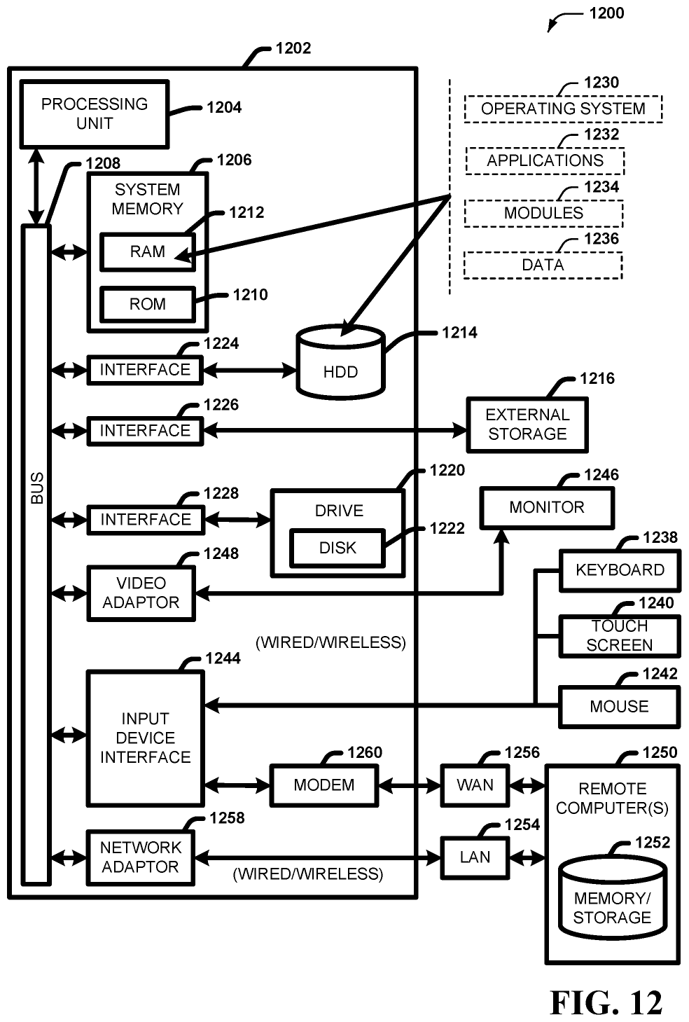

In order to provide a context for the various aspects of the disclosed subject matter, FIG. 12 as well as the following discussion are intended to provide a general description of a suitable environment in which the various aspects of the disclosed subject matter can be implemented. FIG. 12 illustrates a block diagram of an example, non-limiting operating environment in which one or more embodiments described herein can be facilitated. Repetitive description of like elements employed in other embodiments described herein is omitted for sake of brevity.

With reference to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and a drive 1220, e.g., such as a solid state drive, an optical disk drive, which can read or write from a disk 1222, such as a CD-ROM disc, a DVD, a BD, etc. Alternatively, where a solid state drive is involved, disk 1222 would not be included, unless separate. While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and drive 1220 can be connected to the system bus 1208 by an HDD interface 1224, an external storage interface 1226 and a drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above, such as but not limited to a network virtual machine providing one or more aspects of storage or processing of information. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, and/or other program modules that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices. For example, in one or more embodiments, computer executable components can be executed from memory that can include or be comprised of one or more distributed memory units. As used herein, the term “memory” and “memory unit” are interchangeable. Further, one or more embodiments described herein can execute code of the computer executable components in a distributed manner, e.g., multiple processors combining or working cooperatively to execute code from one or more distributed memory units. As used herein, the term “memory” can encompass a single memory or memory unit at one location or multiple memories or memory units at one or more locations.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
calculating, by a system operatively coupled to a processor, expectation values of two Pauli-strings based on a first bit series of a first Pauli-string of the two Pauli-strings and a second bit series of a second Pauli-string of the two Pauli-strings, wherein bit series comprise a first value for a position of an X or Y character in a Pauli string and a second value for a position of a non-X or Y character in the Pauli string.

2. The computer-implemented method of claim 1, further comprising:
selecting, by the system, the two Pauli-strings from a set of two or more Pauli-strings; and
determining, by the system, that the first bit series and the second bit series are the same.

3. The computer-implemented method of claim 2, further comprising:
loading, by the system, probability amplitudes of an index value and an exclusive or result of the index value and the first bit series.

4. The computer-implemented method of claim 3, further comprising:
calculating, by the system, the expectation values of the two Pauli-strings based on the probability amplitudes.

5. The computer-implemented method of claim 1, further comprising:
determining, by the system, that a position of the first value in the first bit series and the second bit series is the same.

6. The computer-implemented method of claim 5, further comprising:
loading, by the system, probability amplitudes of an index value, an exclusive or result of the index value and the first bit series, a second exclusive or result of the index value and the second bit series, and a third exclusive or result of the index value, the second bit series and the first bit series.

7. The computer-implemented method of claim 6, further comprising:
calculating, by the system, the expectation values of the two Pauli-strings based on the probability amplitudes.

8. A system, comprising:
a memory that stores computer executable components; and
a processor, operably coupled to the memory, and that executes the computer executable components stored in the memory, wherein the computer executable components comprise:
an expectation component configured to calculate expectation values of two Pauli-strings based on a first bit series of a first Pauli-string of the two Pauli-strings and a second bit series of a second Pauli-string of the two Pauli-strings, wherein bit series comprise a first value for a position of an X or Y in a Pauli string and a second value for a position of a non-X or Y in the Pauli string.

9. The system of claim 8, wherein the computer executable components further comprise:
a comparison component configured to:
select the two Pauli-strings from a set of two or more Pauli-strings; and
determine that the first bit series and the second bit series are the same.

10. The system of claim 9, wherein the expectation component is further configured to load probability amplitudes of an index value and a an exclusive or result of the index value and the first bit series.

11. The system of claim 10, wherein the expectation component is further configured to calculate the expectation values of the two Pauli-strings based on the probability amplitudes.

12. The system of claim 9, wherein the comparison component is further configured to determine that a position of the first value in the first bit series and the second bit series is the same.

13. The system of claim 12, wherein the expectation component is further configured to load probability amplitudes of an index value, an exclusive or result of the index value and the first bit series, a second exclusive or result of the index value and the second bit series, and a third an exclusive or result of the index value, the second bit series and the first bit series.

14. The system of claim 13, wherein the expectation component is further configured to calculate the expectation values of the two Pauli-strings based on the probability amplitudes.

15. A computer program product comprising a computer readable storage medium having program instructions embodied therewith, the program instructions executable by a processor to cause the processor to:
calculate, by the processor, expectation values of two Pauli-strings based on a first bit series of a first Pauli-string of the two Pauli-strings and a second bit series of a second Pauli-string of the two Pauli-strings, wherein bit series comprise a first value for a position of an X or Y in a Pauli string and a second value for a position of a non-X or Y in the Pauli string.

16. The computer program product of claim 15, wherein the program instructions further cause the processor to:
select the two Pauli-strings from a set of two or more Pauli-strings; and
determine that that that the first bit series and the second bit series are the same.

17. The computer program product of claim 16, wherein the program instructions further cause the processor to load probability amplitudes of an index value and an exclusive or result of the index value and the first bit series.

18. The computer program product of claim 17, wherein the program instructions further cause the processor to calculate the expectation values of the two Pauli-strings based on the probability amplitudes.

19. The computer program product of claim 15, wherein the program instructions further cause the processor to determine that a position of the first value in the first bit series and the second bit series is the same.

20. The computer program product of claim 19, wherein the program instructions further cause the processor to:
load probability amplitudes of an index value, an exclusive or result of the index value and the first bit series, a second exclusive or result of the index value and the second bit series, and a third exclusive or of the index value, the second bit series and the first bit series; and
calculate the expectation values of the two Pauli-strings based on the probability amplitudes.
